(19) United States
(12) Patent Application Publication
(10) Pub. No.: US 2005/0089830 A1
(43) Pub. Date: Apr. 28, 2005

(54) A Scenario Method of Teaching Multiplication and Division Concepts

(76) Inventor: Victoria E. Kahn, San Diego, CA (US)

Correspondence Address: Victoria E. Kahn, 5272 Gaylord Place, San Diego, CA, 92117, US

(21) Appl. No.: 10/904,083

(22) Filed: Oct. 22, 2004

Related U.S. Application Data
(60) Provisional application No. 60/481,541, filed on Oct. 22, 2003.

(51) Int. Cl. G09B 19/02; G09B 1/02

(52) U.S. Cl. 434/191

(57) ABSTRACT

A scenario method for teaching multiplication includes constructing a story in which a student is told that an equal number of objects (X) are to be collected from one or more sub-groups, the number of sub-groups comprising a number Y. The student is next instructed to collect the X number of objects from each of the Y sub-groups into a large group. The student is next instructed to count the number of objects collected in the large group, that number being the product of X*Y.

### CROSS REFERENCE TO RELATED APPLICATIONS

This application claims the benefit of priority of U.S. Provisional Application No. 60/481,541, filed Oct. 22, 2003, the contents of which are hereby incorporated by reference in its entirety for all purposes.

### BACKGROUND

The present invention relates to educational tools, and more particularly to methods for teaching multiplication and division concepts.

Traditionally, multiplication and division has been taught through memorization techniques in which students are quizzed in recalling multiplication and division table using integers from 1-12. Apparati, such as flash cards, have been traditionally used to aid the student in memorizing such tables. While this technique proves effective for most students, it is inadequate from some, as some students, particularly those who may be learning or developmentally disabled, may not be able to recall from rote memory as easily as others.

It has been long known that integration of tactile components and game play in the educational process helps students learn. However, such tactile techniques and game play have not been heretofore integrated in the process of learning basic multiplication and division concepts. Accordingly, what is needed is a method for teaching multiplication and division concepts which integrates these components.

### SUMMARY

The present invention provides improved techniques for teaching multiplication and division concepts using a scenario method in which the student manipulates and counts pieces in a game. Through this play, the student is able to comprehend the concepts of multiplication and division much easier and with little need to resort to memorization.

In a first embodiment, a scenario method for teaching multiplication includes constructing a story in which a student is told that an equal number of objects (X) are to be collected from one or more sub-groups, the number of sub-groups comprising a number Y. Next the student is instructed to collect the X number of objects from each of the Y sub-groups into a large group. Subsequently, the student is instructed to count the number of objects collected in the large group, that number being the product of X*Y.

In a second embodiment, a scenario method for teaching division includes constructing a story in which a student is told that a total number of objects Z are to be moved from a large group and divided into one or more sub-groups Y, each of the sub-groups Y to contain an equal number of objects. Next the student is instructed to move the objects from the large group, into the sub-groups Y until all of the objects have been moved from the large group, and each of the sub-groups contain an equal number of objects. Subsequently, the student is instructed to count the number of items in each of the subgroups, that number being the quotient of Z÷Y

These and other features of the invention will be better understood in view of the following drawings and detailed description.

### BRIEF DESCRIPTION OF THE DRAWINGS

FIG. 1 illustrates a scenario method for teaching multiplication in accordance with one embodiment of the present invention.

FIG. 2 illustrates an exemplary embodiment of the scenario method for teaching multiplication in accordance with the present invention.

FIG. 3 illustrates a scenario method for teaching division in accordance with one embodiment of the present invention.

FIG. 4 illustrates an exemplary embodiment of the scenario method for teaching division in accordance with the present invention.

### DETAILED DESCRIPTION OF EXEMPLARY EMBODIMENTS

FIG. 1 illustrates a scenario method for teaching multiplication in accordance with one embodiment of the present invention. Initially at 110, a story is constructed in which the student is told that an equal number of objects (X) are to be collected from one or more sub-groups, the number of sub-groups comprising a number Y. Subsequently at 120, the student is instructed to collect the X number of objects from each of the Y sub-groups, and places them into a large group. Once collection of the X objects from each of the Y sub-groups is complete, at 130 the student is instructed to count the number of objects in the large group, that number being the product of X*Y.

The process may be repeated for a different number of objects selected from each sub-group X, or for a different number of sub-groups Y.

In an exemplary embodiment of the multiplication method shown in FIG. 1, the student is first presented with the following story:

“When Cowboy Tim goes to the trade shows and fairs to buy new horses, he likes to buy an equal number of fine horses from each trader. He knows that each trader has a separate small corral. Even though he needs to buy from a different number of traders on different trips, he always knows how many traders there will be each time and he knows how many horses he needs to look at from each trader. For example, he sometimes needs to look at three horses from three different traders each (3×3). So, to solve his problem he knows he must herd three horses into each of the three small corrals in the number “3” folder. Then he must herd all of the horses from all of the small corrals into the big corral and, finally, count the total number. Choose a folder with the number of small corrals for the multiplication problem you are learning and help Cowboy Tim buy his new herd.”

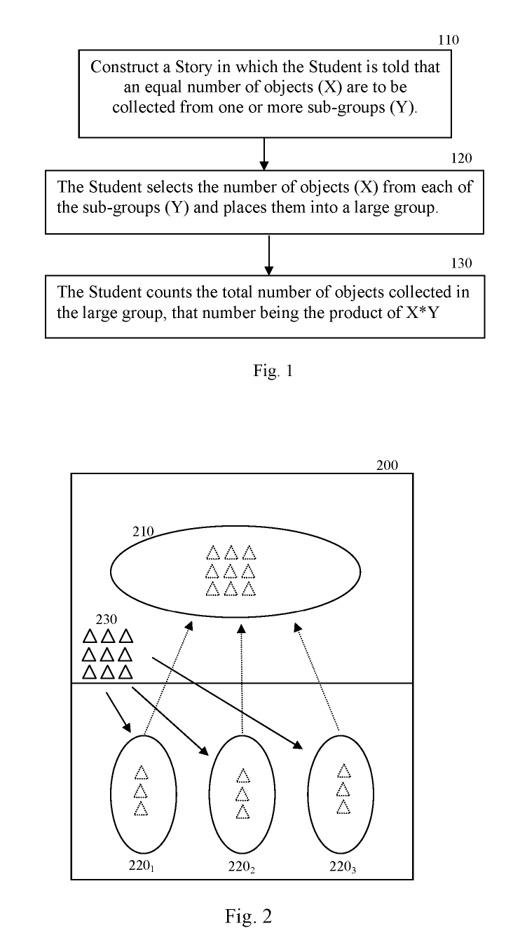

Next, the student chooses, or is next presented with a teaching aid 200, shown in FIG. 2. The teaching aid 200 includes a folder labeled with a number the student is learning how to multiply, for example, the number “3”.

The folder, when open, illustrates a large corral 210 (the “large group” referred to in FIG. 1), three separate small corrals 220₁₋₃ (the “Y sub-groups” referred to in FIG. 1), the number of small corrals 220 corresponding to the folder label number. The student is also provided with a predefined number of horse-shaped markers 230 (the “objects” referred to in FIG. 1), the predefined number representing the product of two multipliers, e.g., nine in an exemplary embodiment. The student is next instructed to place one horse 230 into each of the three small corrals 220₁, 220₂ and 220₃, the process being repeated in succession until three horses are placed into each of the small corrals 220.

After the student has distributed the horses 230 into the small corrals 220, the student is instructed to move the horses 230 from the small corrals 220 into the large corral 230 to determine the total number of horses in Cowboy Tim's herd. In a particular embodiment, the student moves one horse 230 from the first corral 220₁, then one horse from the second corral 220₂, then a third horse from the third corral 220₃, a fourth horse from the first corral, in this manner until all of the horses have been moved from the small corrals 220 to the large corral 230. The student may count consecutively as she moves the horses from the small corrals 220 into the large corral 230 to count to nine, or alternatively, the student may count the total number of horses in the large corral 230 after all have been moved into the large corral 230. In both instances, the student is able to determine that the total number of horses is nine, and that this number corresponds to the product of 3 (sets) and 3 (horses within each set). The process can be used in reverse sequence to teach division concepts, as will be further described below.

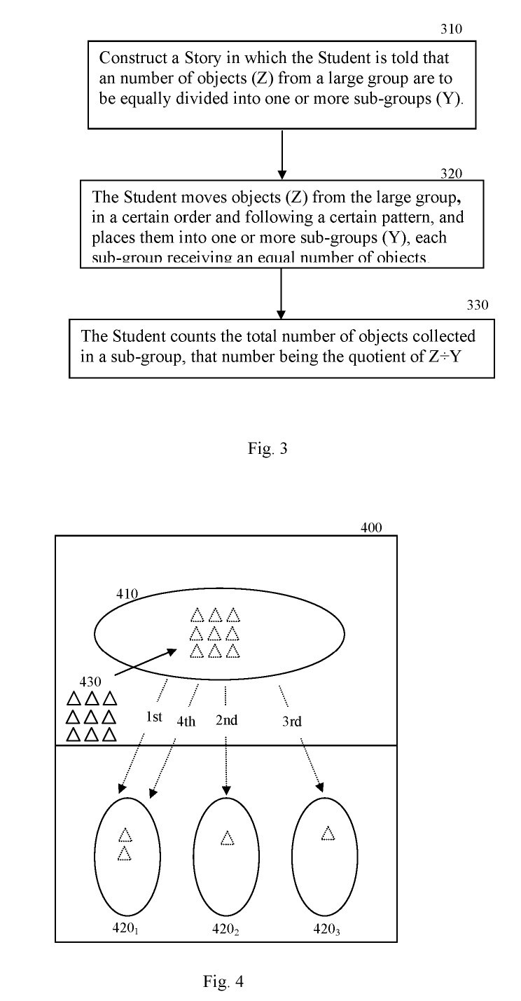

FIG. 3 illustrates a scenario method for teaching division in accordance with one embodiment of the present invention. First at 310, a story is constructed in which the student is told that a total number of objects (Z) are to be divided into one or more sub-groups (Y), each of the sub-groups Y to contain an equal number of objects. Next at 320, the student is instructed to move the objects into the sub-groups Y until all of the objects have been moved from the large group using a certain order and following a certain pattern, and each of the sub-groups contain an equal number of objects. At 330, the student is instructed to count the number of items in each of the subgroups, that number being the quotient of Z÷Y.

In an exemplary embodiment of the division method shown in FIG. 3, the student is first presented with the following story:

“Cowboy Tim raises and sells thoroughbred horses. Usually, he keeps all of his horses in the big corral, but sometimes he herds them into separate smaller corrals so they can exercise and show off their tricks for people who want to buy them. When he does this, he herds them out one at a time. He herds one horse into one small corral, then he returns to the big corral and herds the next horse into the next small corral, then he herds the next, until he has put one horse in each small corral. Then he starts again, the same way and in the same order, until all the horses are in the small corrals and there is an equal number in each corral. Choose a division folder for the number you are learning and help Cowboy Time divide his herd into the separate corrals.”

Next, the student chooses, or is next presented with a teaching aid 400, shown in FIG. 4. The teaching aid 400 includes a folder labeled with a number the student is learning how to divide, for example, the number “3”. The folder, when open, illustrates a large corral 410 (the “large group” as referred to in FIG. 3) and three separate small corrals 420₁₋₃ (the Y sub-groups as referred to in FIG. 3), the number of small corrals 420 corresponding to the folder label number. The student is also provided with a predefined number of horse-shaped markers 430, the predefined number preferably representing a number which is integer divisable by the folder label number, e.g., nine when the folder label number is three. In such an embodiment, the student next places nine horses 430 into the large corral 430.

Once the total number of horses 430 has been placed into the large corral 430, the student is instructed to move the horses 430 one-by-one, from the large corral 230 into small corrals 420₁, 420₂, 420₃ successively.

FIG. 4 illustrates the first four movements in such a process. As shown, the horses 430 are moved in a modulus 3 manner, that is, the student moves a first horse 430 into the first corral 420₁, a second horse 430 into the second corral 420₂, a third horse into the third corral 420₃, a fourth horse into the first corral 420₁, the process continuing until all of the horses have been moved from the large corral 430 into the small corrals 420. In the preferred embodiment when the total number of supplied horses 430 is divisable by the number of small corrals 420, each small corral will hold an equal number of horses. The student is then able to determine the quotient, i.e. the number of horses in each corral, given the total number of horses and the total number of corrals.

Further particularly, the described division and multiplication exercises can be made directly following each other. For example, the multiplication exercise may be first undertaken, the last step being the movement of all of the horses 230 into the large corral 210. This step represents the first operation of the division exercise, and accordingly, the student can continue with a division operation from that point in accordance with the process as described above. In a similar manner, a multiplication exercise may be made following a division exercise, as the division operation concludes with moving an equal number of horses into each of the small corrals 430; that step being the first operation of the multiplication operation, as described above.

The teaching aids 200 and 400 may be formed from a variety of materials. For example, the large and small corrals 210 and 220 may comprise felt pieces of relative size, with the horses 230 also consisting of separate felt pieces or some such material which would permit their removable attachment in the large and small corrals according to the story. In another embodiment, the large and small corrals 210 and 220 may be indicated as drawn circles, and movement of the horses 330 may be recorded as pen/pencil marks within the respective corrals. The reader will appreciate that other apparati may be used alternatively under the present invention. Further, other stories (e.g., ducks which the requisite number of eggs, etc.) may also be used in alternative embodiments under the present invention.

In a particular embodiment of the invention, a teaching aid kit of twelve folders, similar to those shown in FIGS. 2 and 4 is provided, each folder having a single large corral (or similar field), a plurality of small corrals (or similar smaller fields), and a folder label number, the number of small corrals corresponding to the folder label number. For example, the folder having a label number ten would include ten smaller corrals inside thereof. The teaching aid kit may also include a plurality of horse-shaped markers (or other objects) which the student moves during the exercise as described above. The kit may also contain problem cards and appropriate score sheets to enable the teacher to assess student progress.

The outside of each folder may be decorated/labeled with a large Arabic numeral representing its particular number, the word for the number, and an amount of dots to equal the quantity of the number. Such indicia is helpful to students with severe disabilities or students who have not yet learned to read the words or the numerals to choose the appropriate folder by counting the dots, and to work the problems correctly. This labeling also helps students associate written word for the number with both the numeral and the amount or quantity of dots.

In a particular embodiment, the markers 230 and 430 measure ⅛th″ (thickness), being cut out as a ¼ slice of a 1″ diameter circle, having a length of ½″ and a width of ½″, and is made of felt or magnetic material. Each is double sided, consisting of two colors of felt or other material affixed together so as to make the marker a different color on each of its two sides, using enough different colors to distinguish each set of markers from the other sets. The two colors also enable students to “keep their count” when counting large numbers of tokens by turning them as they count, and it will also prevent the markers from one set of 144 from becoming mixed up with the markers of a different set. Each kit may consist of any number of sets of markers, initially beginning with from two to four sets.

In a particular embodiment of the invention, the described processes and operations are implemented as machine readable instruction code (e.g., software) which can be stored on a computer readable medium, such as a compact disc or other type or removable medium, or stored in memory (volatile or non-volatile). In such an embodiment, the instruction code is operable to control a computer or other programmable machine to carry out the operations and processes as described herein.

The foregoing embodiments are only representative of the scope of the presented method and the reader will appreciate that many modifications can be made to the method without departing from the scope of the present invention. It is intended that the scope of the invention be defined by the claims as appended hereto.

1. A scenario method for teaching multiplication concepts, comprising:
constructing a story in which a student is told that an equal number of objects (X) are to be collected from one or more sub-groups, the number of sub-groups comprising a number Y;
instructing the student to collect the X number of objects from each of the Y sub-groups into a large group; and
instructing the student to count the number of objects collected in the large group, that number being the product of X*Y.

2. The method of claim 1, wherein X and Y are integers numbers within the range of one to twelve, inclusive.

3. The method of claim 1, wherein instructing the student to collect the X number of objects comprises instructing the student to physically move each of the X number of objects from the Y sub-groups to the large group.

4. The method of claim 3, wherein instructing the student to count the number of objects comprises instructing the student to sequentially count the number of objects as they are physically moved from the Y sub-groups to the large group.

5. The method of claim 3, wherein instructing the student to count the number of objects comprises instructing the student to sequentially count the number of objects contained in the large group after all of the objects have been physically moved into the large group.

6. A scenario method for teaching division concepts, comprising:
constructing a story in which a student is told that a total number of objects Z are to be moved from a large group and divided into one or more sub-groups Y, each of the sub-groups Y to contain an equal number of objects;
instructing the student to move the objects from the large group into the sub-groups Y until all of the objects have been moved from the large group, and each of the sub-groups contain an equal number of objects; and
instructing the student to count the number of items in each of the subgroups, that number being the quotient of Z÷Y.

7. A scenario method for teaching multiplication and division, the method comprising:
creating a multiplication exercise, comprising:
constructing a story in which a student is told that an equal number of objects (X) are to be collected from one or more sub-groups, the number of sub-groups comprising a number Y;
instructing the student to collect the X number of objects from each of the Y sub-groups into a large group; and
instructing the student to count the number of objects collected in the large group, that number being the product of X*Y comprising a total of Z objects; and
creating a division exercise after completion of the multiplication exercise, comprising:
constructing a story in which the student is told that a total number of objects Z are to be moved from the large group and divided into one or more sub-groups Y, each of the sub-groups Y to contain an equal number of objects, wherein the total number of objects Z is the product of X*Y;
instructing the student to move the objects from the large group, into the sub-groups Y until all of the objects have been moved from the large group, and each of the sub-groups contain an equal number of objects; and
instructing the student to count the number of items in each of the Y subgroups.

8. The method of claim 7, wherein X and Y are integers numbers within the range of one to twelve, inclusive.

9. The method of claim 7, wherein instructing the student to collect the X number of objects comprises instructing the student to physically move each of the X number of objects from the Y sub-groups to the large group.

10. The method of claim 9, wherein instructing the student to count the number of objects comprises instructing the student to sequentially count the number of objects as they are physically moved from the Y sub-groups to the large group.

11. The method of claim 9, wherein instructing the student to count the number of objects comprises instructing the student to sequentially count the number of objects contained in the large group after all of the objects have been physically moved into the large group.

12. The method of claim 7, further comprising instructing the student to perform a multiplication exercise after completion of the division exercise, comprising:
instructing the student to collect the X number of objects from each of the Y sub-groups into a large group; and
instructing the student to count the number of objects collected in the large group, that number being the product of X*Y.

13. A computer program product, resident on a computer readable medium, which is operable to execute instruction code for teaching multiplication concepts, the computer program product comprising:
code to construct a story in which a student is told that an equal number of objects (X) are to be collected from one or more sub-groups, the number of sub-groups comprising a number Y;
code to instruct the student to collect the X number of objects from each of the Y sub-groups into a large group; and
code to instruct the student to count the number of objects collected in the large group, that number being the product of X*Y.

14. The computer program product of claim 13, wherein the code to instruct the student to count the number of objects comprises code to instruct the student to sequentially count the number of objects as they are physically moved from the Y sub-groups to the large group.

15. The computer program product of claim 13, wherein the code to instruct the student to count the number of objects comprises code to instruct the student to sequentially count the number of objects contained in the large group after all of the objects have been physically moved into the large group.

16. The computer program product of claim 13, further comprising code to create a division exercise after completion of the multiplication exercise, comprising:
code to construct a story in which the student is told that a total number of objects Z are to be moved from the large group and divided into one or more sub-groups Y, each of the sub-groups Y to contain an equal number of objects, wherein the total number of objects Z is the product of X*Y;
code to instruct the student to move the objects, from the large group into the sub-groups Y until all of the objects have been moved from the large group, and each of the sub-groups contain an equal number of objects; and
code to instruct the student to count the number of items in each of the Y subgroups, with the answer reflecting the number of objects in one sub group.

17. The method of claim 16, further comprising code to instruct the student to perform a multiplication exercise after completion of the division exercise, comprising:
code to instruct the student to collect the X number of objects from each of the Y sub-groups into a large group; and
code to instruct the student to count the number of objects collected in the large group, that number being the product of X*Y.
